(19) United States
(12) Patent Application Publication
(10) Pub. No.: US 2010/0146914 A1
(43) Pub. Date: Jun. 17, 2010

(54) HORSE BLANKET

(75) Inventor: David Duncan MacDonald, South Hobart, TAS (AU)

Correspondence Address: BROOKS KUSHMAN P.C., 1000 TOWN CENTER, TWENTY-SECOND FLOOR, SOUTHFIELD, MI, 48075, US

(73) Assignee: MACRAM PTY LTD, South Hobart, TAS (AU)

(21) Appl. No.: 12/668,510

(22) PCT Filed: Jul. 11, 2007
(86) PCT No.: PCT/AU07/00948

§ 371 Date: Jan. 22, 2010

(30) Foreign Application Priority Data
Jul. 11, 2006 (AU) 2006903722

(51) Int. Cl. A01K 13/00

(52) U.S. Cl. 54/79.1

(57) ABSTRACT

A horse blanket (1) has an overlay (2) of traditional shape for a horse blanket and a set of protuberances (3) which stand proud of the lower surface of the overlay (2). The protuberances (3) are arranged substantially according to a rectangular grid that overlies only a portion of the underside of the overlay (2). Each protuberance (3) is approximately triangular in cross-section and has a base portion (11) that is fixed in any suitable manner to the overlay (2). The region (12) that would otherwise be the apex of the triangle is truncated and rounded. The protuberances (3) are made from gas-filled plastic so that each protuberance (3) is formed as a longitudinally extending, hollow body.

### FIELD OF THE INVENTION

The present invention relates to horse blankets and the like.

### BACKGROUND OF THE INVENTION

Horse blankets are also known as horse rugs, but throughout this specification (including the claims) we use the term “horse blanket”.

Horse blankets are used today across all sectors of the horse industry. They are used for all sorts of reasons including for keeping a horse warm in the winter months, for keeping insects off the horse and for stopping the sun from bleaching the coats of show horses. This means that blankets are used all year round. Unfortunately the styles of existing blankets are detrimental to the horses health for a number of reasons.

Traditional horse blankets lay flat against the horses' hair. The weight of the blanket flattens the hair. In cold climates a horse's natural defence against the cold is the ability of its hair to stand upright. When the hair is standing rigid the horse's body heat is trapped between the hairs as it is released from the body. This layer of hot air over the skin of the horse forms a barrier to the outside cold air. When the blanket is placed over the hair the hair is flattened, removing this natural barrier. This is why many horse owners these days refuse to use blankets during the colder months and just let the horse's natural blanket do its job.

This flattening of the hair also reduces the ability of the skin of the horse to breathe properly. This is evident in the warmer months when the horse is sweating. When the hair is not inhibited with a blanket and the horse sweats, the hair actually moves up and down. This allows the sweat to escape the pores and also helps to dry the sweat and moderate the temperature changes of the horse's body. When the hair is flattened (compressed) by the weight of the blanket this heat regulation is greatly impeded.

The build up of sweat due to the increased heat causes skin conditions such as blocked sweat glands. This in turn causes the skin to become itchy causing the horse to rub these areas which often leads to hair loss and scabs. Heat lumps are also a problem which often result from lack of sweat gland function

### SUMMARY OF THE INVENTION

In contrast to a traditional horse blanket, the present invention provides a horse blanket comprising:
an overlay having upper and lower surfaces; and
on at least a portion of the lower surface of the overlay, a plurality of protuberances each of which stands proud of that lower surface.

It is preferred that substantially all of the protuberances have insulating properties.

It is preferred that substantially every protuberance is readily compressible by the forces that are generated when the blanket is being worn by a horse which is rolling.

It is preferred that substantially all of the protuberances are of a gas-filled plastics material.

It is preferred that each protuberance is attached to the lower surface of the underlay.

It is preferred that substantially all of the protuberances:
are in the range of 80 mm to 100 mm in length; and
stand proud of the overlay by a distance of between 10 mm and 30 mm.

Alternatively, it is preferred that substantially all of the protuberances:
are in the range of from 380 mm to 410 mm in length; and
stand proud of the overlay by a distance of between 10 mm and 30 mm.

### BRIEF DESCRIPTION OF THE DRAWINGS

In order that the invention may be more readily understood, preferred embodiments of it are described with reference to the drawings in which:

FIG. 1 is a view an embodiment of the present invention, with the blanket opened out and viewed from what would be the underside of the blanket when placed on a horse;

FIG. 2 is a cross-sectional view of a detail of the embodiment of FIG. 2; and

FIG. 3 is a view of another embodiment of the present invention, with the blanket opened out and viewed from what would be the underside of the blanket when placed on a horse.

It will be seen that embodiments of the present invention allow for more circulation of air over the body of the horse and reduce the area of contact between the blanket and the skin when compared with traditional horse blankets.

### DESCRIPTION OF PREFERRED EMBODIMENTS OF THE INVENTION

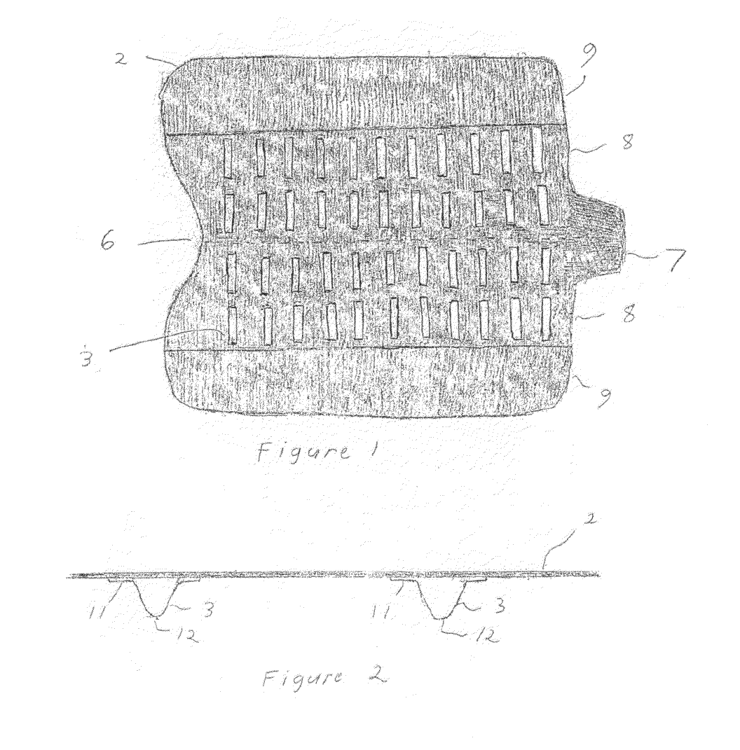

FIG. 1 shows a horse blanket 1 according to one preferred embodiment of the present invention. The horse blanket 1 includes an overlay 2 of traditional shape for a horse blanket, being approximately rectangular with a bight portion 6 that lies adjacent the horse's neck and a flap portion 7 that lies over the horse's rump when in use. Also as with a traditional horse blanket, the overlay 2 has substantially longitudinally extending portions 8 that lie on the horse's back and flanks, and portions 9 that are intended for tying under the horse's belly.

The horse blanket 1 also has a set of protuberances such as 3 which stand proud of the lower surface of the overlay 2. According to the embodiment that is shown in FIG. 1, these protuberances are arranged substantially according to a rectangular grid that overlies only the portions 8 of the overlay 2.

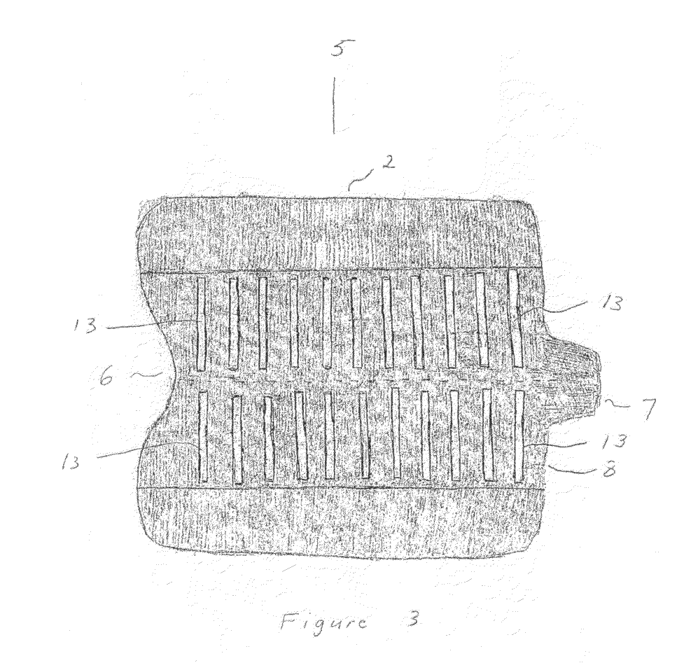

FIG. 2 is a cross-sectional view through two adjacent protuberances. Each protuberance 3 is approximately triangular in cross-section and has a base portion 11 that is fixed in any suitable manner to the overlay 2. The region 12 that would otherwise be the apex of the triangle is truncated and rounded. This rounding of the protuberance more results in lower pressure on the horse's skin at the contact areas between the skin and the protuberance.

The protuberances 3 can be made of any suitable material. They can be of solid deformable construction (such as lengths of natural or synthetic cording, or solid materials such as plastics or other synthetic), or of a gas-filled plastic or fluid filled plastic or the like. It is preferred that each protuberance is formed as a longitudinally extending, body. This provides a cushioning effect when the horse is rolling. The protuberances 3 also provide some insulating effect. According to the embodiment of FIG. 1, each protuberance is about 100 millimetres long and stands between 10 millimetres and 30 millimetres, and preferably 15 millimetres, proud of the overlay 2. The protuberances are spaced at 100 millimetre intervals along what would be the longitudinal dimension of the horse.

FIG. 3 shows a horse blanket 5 according to another preferred embodiment of the invention. The embodiment of FIG. 3 differs from the embodiment of FIG. 1 only in that the length of the protuberances is different, being about 400 millimetres for the embodiment of FIG. 3.

It will be evident that specific dimensions of the protuberances can be optimized for a particular horse in a particular environment. Optimization involves the consideration that the smaller the total contact area between the protuberances and the horse:
results in there being less area of skin that may be disfigured, but at the same time;
increasing the pressure in the area of contact and increasing the risk of damage or injury to the skin.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

“Comprises/comprising” when used in this specification is taken to specify the presence of stated features, integers, steps or components but does not preclude the presence or addition of one or more other features, integers, steps, components or groups thereof.

The claims defining the invention are as follows:

1. A horse blanket comprising:
an overlay having upper and lower surfaces; and
on at least a portion of the lower surface of the overlay, a plurality of protuberances each of which stands proud of that lower surface.

2. A horse blanket as claimed in claim 1, in which substantially all of the protuberances have insulating properties.

3. A horse blanket as claimed in any one of the preceding claims, in which substantially every protuberance is readily compressible by the forces that are generated when the blanket is being worn by a horse which is rolling.

4. A horse blanket as claimed in any one of the preceding claims, in which substantially all of the protuberances are of a gas-filled plastics material.

5. A horse blanket as claimed in any one of the preceding claims, in which each protuberance is attached to the lower surface of the underlay.

6. A horse blanket as claimed in any one of the preceding claims, in which substantially all of the protuberances:
are in the range of 80 mm to 100 mm in length; and
stand proud of the overlay by a distance of between 10 mm and 30 mm.

7. A horse blanket as claimed in any one of claims 1 to 5, in which substantially all of the protuberances:
are in the range of from 380 mm to 410 mm in length; and
stand proud of the overlay by a distance of between 10 mm and 30 mm.

8. A horse blanket as claimed in any one of claims 1 to 6, substantially as described with reference to FIGS. 1 and 2 of the drawings.

9. A horse blanket as claimed in any one of claims, 1, 2, 3, 4, 5 and 7, substantially as described with reference to FIGS. 2 and 3 of the drawings.
